(19) United States
(12) Patent Application Publication
(10) Pub. No.: US 2010/0310192 A1
(43) Pub. Date: Dec. 9, 2010

(54) DOCUMENT STORAGE SYSTEM

(76) Inventors: Anjaneyulu Seetha Rama KUCHIBHOTLA, Bangalore (IN); Guruprasad CHINTAKUNTA, Bangalore (IN); Sitaram RAMACHANDRULA, Bangalore (IN); Sriganesh MADHVANATH, Bangalore (IN); Deivanayagam RAMAKRISHNAN, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/506,275

(22) Filed: Jul. 21, 2009

(30) Foreign Application Priority Data
Jun. 5, 2009 (IN) 1321/CHE/2009

(51) Int. Cl. G06K 9/36

(52) U.S. Cl. 382/282; 382/305

(57) ABSTRACT

Methods for storing and managing hard copy documents and their modified versions are disclosed. Specifically, a method of storing a document and one or more related images of alterations made to the document, comprising capturing an image of the document; storing the image of the document in memory; capturing an image of an altered version of the document; comparing the image of the document to the image of the altered version of the document; extracting the differences between the image of the document and the image of the altered version of the document; creating an image of the extracted differences between the image of the document and the image of the altered version of the document; and storing the image of the extracted differences in memory.

### RELATED APPLICATIONS

Benefit is claimed under 35 U.S.C. 119(a)-(d) to Foreign application Serial No. 1321/CHE/2009 entitled “Document Storage System” by Hewlett-Packard Development Company, L.P., filed on 5 Jun. 2009, which is herein incorporated in its entirety by reference for all purposes.

### BACKGROUND

Many organizations, particularly in emerging markets, primarily use printed hard copy documents in their processes. Also in many cases these organizations receive hard copy documents such as invoices from other organizations that may need to be processed by the organization. However, using hard copy documents to conduct business may cause difficulties in an organization.

For example, physical storage and movement of hard copy documents can be costly. It also may be difficult to determine the status or location of such hard copy documents, resulting in inefficiencies in workflow. Authentication of hard copy documents also can be time-consuming. Finally, because hard copy documents generally require sequential processing, it may be difficult for multiple users to work on a hard copy document simultaneously, and may be difficult to incorporate changes from multiple users.

Despite all these difficulties, businesses continue to use hard copy documents. Many businesses simply are not willing to or cannot transition to an entirely paperless business processes using computers.

### BRIEF DESCRIPTION OF THE DRAWINGS

FIG. 1A is a block diagram of a document storage system showing the status of a hard copy document as it moves through the system, according to an embodiment of the disclosure.

FIG. 1B is a block diagram of the document storage system of FIG. 1A showing the status of an altered version of the hard copy document as it moves through the system, according to an embodiment of the disclosure.

FIG. 2 is a flow chart showing the steps in a process of storing documents according to an embodiment of the disclosure.

### DETAILED DESCRIPTION

The present illustrative methods and systems may be adapted to store printed documents. Specifically, the present illustrative systems and methods may, among other things, be adapted to store an image of a printed document and related images of subsequent changes made to the printed document. Changes may be stored as overlays, each overlay including the differences between one version of the document and the next version of the document. Images thus can be reassembled to produce any version of a document in the workflow, even without physical access to the original document or current document. Further details of the present illustrative document storage systems and methods are provided below.

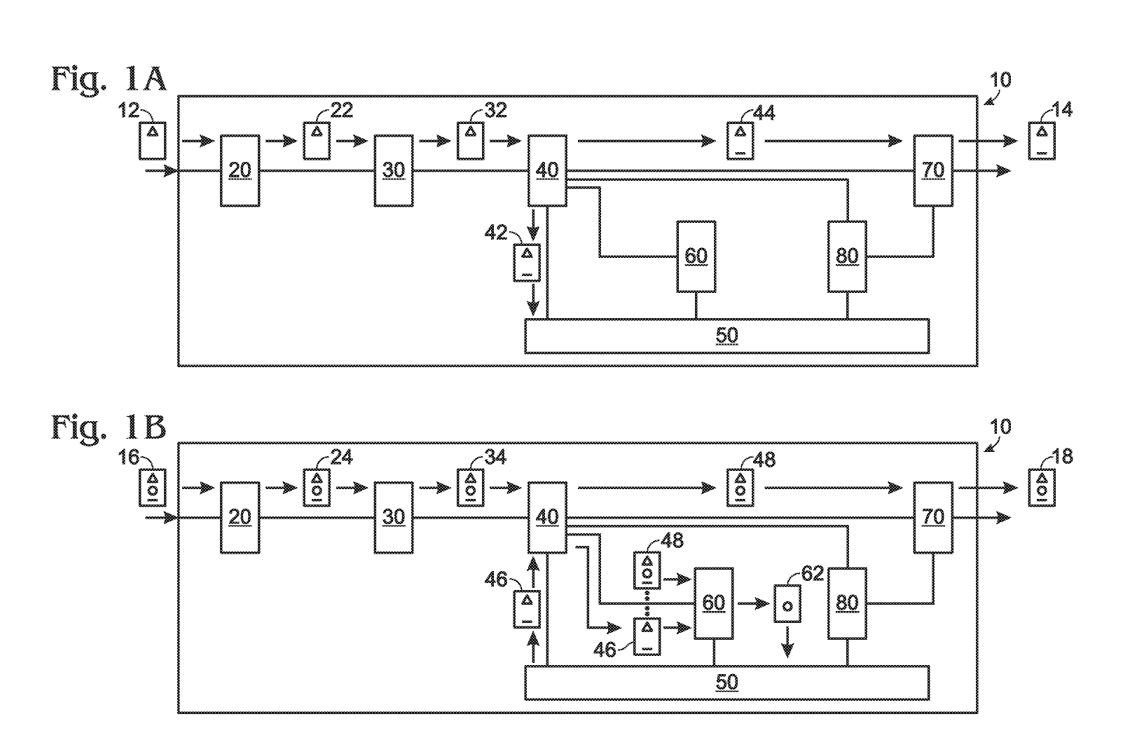

FIG. 1A shows a document storage system 10. The document storage system 10 may include one or more of an image capture device 20, an image processor 30, an input processor 40, memory 50, a comparison processor 60, an output processor 70, and a hard copy document processor 80. Also shown in FIG. 1A is an example original hard copy document 12 that has not previously been entered into the system. Original hard copy document 12 may be any physical record and may include text, data, figures, graphs, pictures, notations, or any other information capable of documentation. In the present example, original hard copy document 12 is shown having content represented by a triangle in an upper region of a page of media.

As indicated, system 10 may be used to associate an identifier with an original hard copy document 12, and to produce an identified hard copy document 14 that includes such identifier. This is shown generally in FIG. 1A, where processing of hard copy document 12 is tracked through the system by showing an image of the original document as it progresses through components that may be integrated into system 10.

When original hard copy document 12 enters system 10, the document is sent to image capture device 20 which may be capable of capturing an image of the hard copy document. For example, image capture device 20 may be a scanner, all-in-one printer, multi-function printer, or digital camera. Image capture device 20 also may be configured to capture metadata from original hard copy document 12. Metadata may be captured from the content of the hard copy document, such as texture, feature points, or hash generated from the content. Alternatively, metadata may be supplied by a user of system 10 by swiping an identity card, entering information using alphanumeric keys provided on system 10, or using an application ported into system 10.

Once an image has been captured (shown at 22), the captured image may be transmitted to image processor 30. Image processor 30 may be configured to recognize an identifier, if present, on captured image 22. As will be appreciated, a hard copy document need not have an identifier the first time it is entered into system. For purposes of illustration, hard copy document 12 is shown without an identifier. Accordingly, in the example shown in FIG. 1A, captured image 22 does not include an identifier.

If image processor 30 does not recognize an identifier, image processor 30 may direct the reviewed image (shown at 32) to input processor 40, which may be configured to generate an identifier. The identifier may be any suitable indicator capable of distinguishing the present image from another image. For example, the identifier may be a unique barcode that may be printed directly on the hard copy document, or on a label that may be affixed to the hard copy document. Alternatively, or additionally, the identifier also may be data supplied by a user of the system, or may be defined by metadata extracted from or related to the hard copy document. For example, the identifier may be defined by feature points found on the hard copy document, or any other metadata gathered by image capture device 20.

Input processor 40 also may assign or identify certain additional information related to the image. For example, input processor 40 may assign a version number, indicate the employee that modified the version, indicate the time the document was last altered or entered into system 10, and other related information. This additional information may be found in metadata of the hard copy document. In some embodiments, the additional information may be encoded in the manner similar to that used to encode the identifier, such as in a barcode. Similar to the identifier, the additional information may be parsed by system 10. It should be appreciated that the additional information may be updated each time the hard copy document is entered into system 40.

In the example of FIG. 1A, the identifier is represented by a line adjacent the lower edge of the hard copy document. After input processor 40 generates and assigns the hard copy document an identifier, an identified image 42 may be stored in memory 50. The identifier may be stored with identified image 42 for future reference or retrieval. A copy of the identified image (shown at 44) may be transmitted to output processor 70. In some embodiments, output processor 70 may include a printer capable of printing the identifier on the original hard copy document to produce identified original document 14. Alternatively, a label may be printed for placement on original hard copy document 12 to produce the identified document, or a copy of the original document may be generated with the identifier thereon to produce the identified original document. Thereafter, identified original document 14 may return to regular workflow.

System 10 also may include a document processor 80 operably connected to input processor 40, memory 50 and output processor 70. Document processor 80 may be configured to retrieve selected identified images from memory 50 and send the identified images to output processor 70 or permit a user to view and/or alter an electronic version of selected images. The selected identified images may be printed and sent into regular workflow.

FIG. 1B shows the document storage system of FIG. 1A processing a modified hard copy document 16, which is a physically altered version of document 14 from FIG. 1A. In this example, it will be understood that identified image 42 (having content in the form of a triangle in an upper region of the page) has been saved in memory 50 with an identifier that will be decoded when modified hard copy document 16 (having an added circle in a central region of the page) is entered into system 10. As will be described in detail below, when the previously-identified image (shown at 46) is compared to a corresponding image of modified hard copy document 16, a difference image (including the extracted differences between the original and modified documents, both identified) may be produced (having only the added circle in the central region of the page) and saved in memory 50.

As described above, when modified document 16 is entered into system 10, image capture device 20 may capture an image of the hard copy document. The resulting captured image (shown at 24) may then be transmitted to image processor 30, which may be configured to review the captured image to determine whether the captured image includes an identifier for use in identifying the captured image.

Upon noting an identifier associated with captured image 24, image processor 30 may direct the reviewed image (shown at 34) to input processor 40. As noted above, reviewed image 34 may include additional information such as the document version, the last person to alter the document, and the last time the document was entered into system 10. The additional information may be updated by input processor 40 when the hard copy document is entered into system 10. For example, a new document version may be assigned, and a new editor and/or time stamp may be entered.

Using the identifier, input processor 40 then may retrieve previously-identified image 46 using the identifier derived from reviewed image 34. Input processor 40 then may transmit the previously-identified image 46 and a copy of the reviewed image (shown at 48) to comparison processor 60. Comparison processor 60 may compare images 46 and 48, extract the differences between the images, and produce a difference image 62 containing the extracted differences. Comparison processor 60 may then store the difference image 62 in memory 50.

Difference image 62 may be related in memory 50 to previously-identified image 46 for future retrieval therewith. The identifier may be the same so as to associate difference image 62 and previously-identified image 46 in memory 50. Difference image 62 also may include updated additional information. For example, difference image may include the new version number, time entered, and person or employee that made the alterations. Upon retrieval in a future operation, the difference image may be re-integrated with the previously-identified image to establish a previously-identified modified image for comparison to a further-modified image so as to extract the differences between modified and further-modified documents. It thus will be appreciated that the hard copy document may be stored in memory as an identified image and one or more related difference images representing successive modifications to the hard copy document. Accordingly, with each successive processing of the hard copy document, a difference image of the most recent modifications to the hard copy document (those made since the previous processing of the document) are captured and stored.

Additionally, system 10 may permit a user to access and alter a copy of image saved in memory 50. The user may access the copied image from memory 50 through document processor 80. After the copied image is retrieved by document processor 80, the user may electronically alter the copied image. For example, the user may review the copied image for approval or insert electronic comments. After electronic alterations have been made, the copied image may be sent from document processor 80 to input processor 40. Thereafter, the process described above with reference to FIG. 1B is followed to extract the electronic differences present in the copied image. Specifically, the copied image is sent to input processor 40 in the same state as reviewed image 34 and is processed in the same manner.

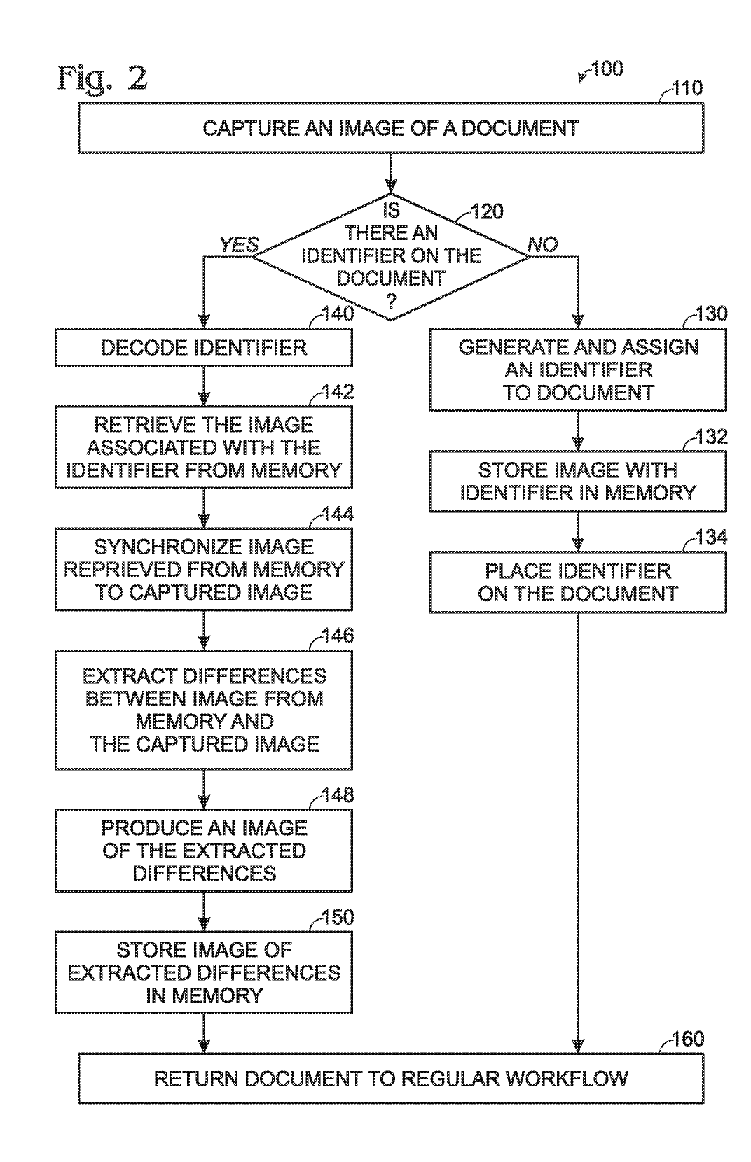

FIG. 2 is a flow chart showing an illustrative example of a process 100 by which a document may be stored according to the present disclosure. Process 100 may be initiated upon capturing an image of a hard copy document as indicated at 110. The captured image thereafter may be reviewed to determine whether the captured image contains an identifier (as indicated at 120).

If no identifier is noted, an identifier is generated and assigned to the document (as indicated at 130). An identified image is then stored in memory, typically, along with the identifier (as indicated at 132). The identifier will accommodate future retrieval of the identified image from memory upon receipt of the document in a subsequent processing operation. Once generated, the identifier may be placed on the hard copy document (as indicated at 134). After the identifier has been placed on the hard copy document, and the image of the document has been stored in memory with the identifier, the hard copy document may return to regular workflow (as indicated at 160).

Once back in regular workflow, alterations, such as notes, marks, or other appropriate annotations may be made on the hard copy document. For example, if the hard copy document is a test that a student has taken, the test grader may place notes, comments, and/or grades on the hard copy document. If the hard copy document is participating in a hard copy workflow those participating in the workflow may annotate the document as it moves from one state to another. If the hard copy document is a medical case sheet the document would contain symptoms and diagnosis as record by a doctor during different visits to the hospital.

Subsequently, the modified document may be reintroduced to the document storage system, and an image of the modified document may be captured (as indicated at 110). Upon determining that there is an identifier associated with the hard copy document, the identifier may be decoded (as indicated at 140). Once the identifier has been decoded, the corresponding previously-identified image is retrieved from memory (as indicated at 142). The previously-identified image may then be synchronized with the captured image for subsequent comparison of the images (as indicated at 144). Differences between the captured image and the corresponding previously-identified image are extracted (as indicated at 148) and the extracted differences are stored in memory (as indicated at 150).

For example, if an “X” were placed in the lower left corner of the hard copy document, then the “X” in the lower left hand corner would be extracted. However, the two images must be synchronized to ensure only the differences between the documents are extracted. The process of synchronizing, or image registration, may include aligning and scaling the images to one another. Image registration may be performed by any of the well known methods including a) area-based methods such as the Fourier method, or b) feature-based methods such as SIFT and RANSAC. After completing image registration, any annotations may be extracted by calculating the binary difference between the images.

To extract the differences between the images the captured image and the previously-identified image (retrieved from memory) are binarized. Next, the difference between the binarized images may be calculated. For example, the calculation may be made in a 3×3 pixel neighborhood to determine if there is a difference between pixels in the images. This calculation may be completed for each pixel to extract any differences between the images.

Once all the differences have been extracted, an image of the extracted differences may be created. The newly created image may be stored in memory. Additionally, the image of the extracted differences may be related in memory to the image retrieved from memory for comparison. This way the original image of the document is saved and the image of the alterations to the document are saved together for future reference and comparison. Upon completion, the hard copy document that was entered into process may return to regular workflow where additional alterations may be made.

While particular forms of the invention have been illustrated and described herein, it will be apparent that various modifications and improvements can be made to the invention. Moreover, individual features of embodiments of the invention may be shown in some drawings and not in others, but those skilled in the art will recognize that individual features of one embodiment of the invention can be combined with any or all the features of another embodiment. Accordingly, it is not intended that the invention be limited to the specific embodiments illustrated. It is intended that this invention to be defined by the scope of the appended claims as broadly as the prior art will permit.

I claim:

1. A method of recording modifications to a hard copy document, the method comprising:
capturing a image of the document;
storing the image of the document in memory;
capturing an image of an altered version of the document;
comparing the image of the document to the image of the altered version of the document;
extracting the differences between the image of the document and the image of the altered version of the document;
creating an image of the extracted differences between the image of the document and the image of the altered version of the document; and
storing the image of the extracted differences in memory.

2. The method of claim 1 further comprising assigning the document and the image of the document an identifier.

3. The method of claim 2 wherein the step of assigning the document an identifier includes capturing metadata from the document.

4. The method of claim 3 further comprising reading the identifier on the image of the altered version of the document to locate the image of the document stored in memory so the image of the altered version may be compared to the image of the document.

5. The method of claim 1 wherein the step of comparing the image of the document to the image of the altered version of the document includes combining the stored image of the document and one or more related stored images of the extracted differences for comparison to the altered version of the document.

6. A document storage system adapted to store an image of a document and one or more related images of alterations made to the document, comprising:
an image capture device capable of capturing an image of the document and an image of an altered version of the document;
memory for storing the image of the document captured by the image capture device; and
an extraction device configured to compare the image of the document to the image of the altered document, to extract the differences between the image of the document and the image of the altered document, and to produce an image of the extracted differences;
wherein the image of the extracted differences is stored in memory.

7. The document storage system of claim 6 further comprising an input processor configured to generate and assign an identifier to the document and the image of the document.

8. The document storage system of claim 7 wherein the identifier is metadata captured from the document by the image capture device.

9. The document storage system of claim 7 wherein the input processor is further configured to decode the identifier and retrieve the image of the document from memory.

10. The document storage system of claim 6 wherein the image of the document and the image of the extracted differences are related when stored in memory.

11. A document storage system configured to store an image of a document and a related image of alterations made to the document comprising:
memory capable of storing one or more images;
an image capture device for capturing an image of the document and an altered version of the document; and
an extraction device configured to extract the differences between the images of the document and the altered version of the document and produce an image of the extracted differences;
wherein the image of the extracted difference is stored in memory and associated in memory with the image of the document.

12. The document storage system of claim 11 further comprising an input processor configured to generate and assign an identifier to the document and the image of the document.

13. The document storage system of claim 12 wherein the identifier is metadata captured from the document by the image capture device.

14. The document storage system of claim 12 wherein the input processor is further configured to decode the identifier and retrieve the image of the document from memory based upon the decoded identifier.
